(19) United States
(12) Patent Application Publication
(10) Pub. No.: US 2023/0222926 A1
(43) Pub. Date: Jul. 13, 2023

(54) PREDICTING A REROUTE FOR A PLANNED FLIGHT OF AN AIRCRAFT

(71) Applicant: The Boeing Company, Chicago, IL (US)

(72) Inventors: Samet M. Ayhan, Fairfax, VA (US); Italo Romani de Oliveira, Sao Jose dos Campos (BR); Euclides Carlos Pinto Neto, Sao Jose dos Campos (BR); Pablo Costas Alvarez, Madrid (ES); Michael Biglin, Charleston, SC (US)

(21) Appl. No.: 17/573,254

(22) Filed: Jan. 11, 2022

(51) Int. Cl. G08G 5/00; G06N 20/00

(52) U.S. Cl. CPC G08G 5/0039; G06N 20/00

(57) ABSTRACT

A method is provided for predicting a reroute for a planned flight of an aircraft. The method includes building a machine learning model to predict a reroute on a future date of a planned flight of an aircraft. The machine learning model is built in a batch process that includes accessing reroute data and weather data, and performing a data wrangling of the reroute data and the weather data to produce a collection of data keyed by date. Candidate machine learning models are built using a training set produced from the collection of data. The candidate machine learning models are evaluated, and the machine learning model is selected from the candidate machine learning models based on the evaluation. And the machine learning model is output for deployment to classify the future date as having a reroute advisory issued, and predict a reroute on the future date.

### TECHNOLOGICAL FIELD

The present disclosure relates generally to aircraft operations and, in particular, to predicting a reroute for a planned flight of an aircraft.

### BACKGROUND

Aircraft and in particular commercial aircraft typically operate in an airspace system served by an air navigation service provider (ANSP). The airspace system includes an airspace, infrastructure and rules, regulations and the like for navigating the airspace. The ANSP is generally a public or private entity that provides air navigation services, and manages air traffic for an organization, region or country. One example of an ANSP in the United States is the Federal Aviation Administration (FAA). Examples of suitable airspace systems include the National Airspace System (NAS) and the new NextGen system that are served by the FAA.

In the airspace system, the ANSP may authorize planned routes of flights of aircraft in its airspace. In this manner, the ANSP may ensure that the flights satisfy rules and constraints to which the aircraft is subject when in the airspace system. The ANSP may also reroute an aircraft off its planned route in the airspace, often due to circumstances such as weather. One manner by which the ANSP may reroute a flight is by issuing a reroute advisory. FAA Office of Aviation Policy and Plans (APO) estimates for 2019 show the cost of delayed flights rose by 9.3 percent, from $30.2 to $33.0 billion, an increase of $2.8 billion. Most of this increase was due to inefficiency in the NAS caused by inability to accurately predict future states of airspace and airports that often leads to rerouting of aircraft.

It would therefore be desirable to have a system and method that takes into account at least some of the issues discussed above, as well as other possible issues.

### BRIEF SUMMARY

Example implementations of the present disclosure are directed to aircraft operations and, in particular, to predicting a reroute for a planned flight of an aircraft. Example implementations may enable aviation authorities and airlines to more accurately perform flight planning, scheduling and resource management. This may result in improvement in a number of performance areas of air traffic management, including safety, capacity, efficiency and environmental impact. An accurate prediction of the impacted regions and available routes capacity may enable better decision-making for managing airspace and airports, allowing a higher level of automation and thereby reducing the workload of air traffic controllers.

To deliver an accurate prediction of reroutes, example implementations may use reroute data that describes historical reroute advisories with historical reroutes issued by an ANSP such as the FAA, and related weather data. The data may be large in volume, streamed at high velocity, uncorrelated and noisy. Example implementations may therefore continuously process this incoming raw data and make it available for use in a collection of data, and a non-intuitive correlation of raw data may make use of a set of microservices of considerable complexity. Candidate machine learning models may be built in which the machine learning models learn from the historical reroutes, weather data and perhaps other salient features, and one of the candidate machine learning models may be selected for deployment. Example implementations may be exposed with a client application such as a web-based client application, which may be integrated with a flight planning system.

The present disclosure thus includes, without limitation, the following example implementations.

Some example implementations provide an apparatus for predicting a reroute for a planned flight of an aircraft, the apparatus comprising: a memory configured to store computer-readable program code; and processing circuitry configured to access the memory, and execute the computer-readable program code to cause the apparatus to at least: build a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, the batch process including the apparatus caused to: access reroute data that describes historical reroute advisories with historical reroutes issued by the ANSP for flights in the airspace on certain dates over a given time period; access weather data that describes weather in the airspace on the certain dates; perform a data wrangling of the reroute data and the weather data to produce a collection of data that includes the reroute data and the weather data keyed by date; build candidate machine learning models to predict the reroute on a given date that is classified as having a reroute advisory issued by the ANSP, using a training set produced from the collection of data; evaluate candidate machine learning models to determine at least one evaluation metric of the candidate machine learning models; and select the machine learning model from the candidate machine learning models based on the at least one evaluation metric; and output the machine learning model for deployment to classify the future date of the planned flight as having a reroute advisory issued by the ANSP, and predict and thereby produce a predicted reroute on the future date of the planned flight, based on forecasted weather data for the future date.

Some example implementations provide a method of predicting a reroute for a planned flight of an aircraft, the method comprising: building a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, the batch process including: accessing reroute data that describes historical reroute advisories with historical reroutes issued by the ANSP for flights in the airspace on certain dates over a given time period; accessing weather data that describes weather in the airspace on the certain dates; performing a data wrangling of the reroute data and the weather data to produce a collection of data that includes the reroute data and the weather data keyed by date; building candidate machine learning models to predict the reroute on a given date that is classified as having a reroute advisory issued by the ANSP, using a training set produced from the collection of data; evaluating candidate machine learning models to determine at least one evaluation metric of the candidate machine learning models; and selecting the machine learning model from the candidate machine learning models based on the at least one evaluation metric; and outputting the machine learning model for deployment to classify the future date of the planned flight as having a reroute advisory issued by the ANSP, and predict and thereby produce a predicted reroute on the future date of the planned flight, based on forecasted weather data for the future date.

Some example implementations provide a computer-readable storage medium for predicting a reroute for a planned flight of an aircraft, the computer-readable storage medium being non-transitory and having computer-readable program code stored therein that, in response to execution by processing circuitry, causes an apparatus to at least: build a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, the batch process including the apparatus caused to: access reroute data that describes historical reroute advisories with historical reroutes issued by the ANSP for flights in the airspace on certain dates over a given time period; access weather data that describes weather in the airspace on the certain dates; perform a data wrangling of the reroute data and the weather data to produce a collection of data that includes the reroute data and the weather data keyed by date; build candidate machine learning models to predict the reroute on a given date that is classified as having a reroute advisory issued by the ANSP, using a training set produced from the collection of data; evaluate candidate machine learning models to determine at least one evaluation metric of the candidate machine learning models; and select the machine learning model from the candidate machine learning models based on the at least one evaluation metric; and output the machine learning model for deployment to classify the future date of the planned flight as having a reroute advisory issued by the ANSP, and predict and thereby produce a predicted reroute on the future date of the planned flight, based on forecasted weather data for the future date.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates one type of vehicle, namely, an aircraft that may benefit from example implementations of the present disclosure;

FIG. 2 illustrates an aircraft manufacturing and service method, according to some example implementations;

FIG. 3 illustrates a system for predicting a reroute for a planned flight of an aircraft, according to some example implementations;

FIG. 4 is a map of precipitable water (PW) in an airspace, according to some example implementations;

FIG. 5 illustrates the map of PW, and further illustrates similar maps of convective available potential energy (CAPE), air potential temperature (APT), and convective inhibition (CI), according to some example implementations;

FIG. 6 illustrates graphical user interfaces (GUIs) that may be generated by a client application, according to some example implementations;

FIGS. 7A, 7B, 7C, 7D, 7E and 7F are flowcharts illustrating various steps in a method of predicting a reroute for a planned flight of an aircraft, according to example implementations; and

FIG. 8 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure relate generally to vehicular engineering and, in particular, to one or more of the design, construction, operation or use of vehicles. As used herein, a vehicle is a machine designed as an instrument of conveyance by land, water or air. A vehicle designed and configurable to fly may at times be referred to as an aerial vehicle, an aircraft or the like. Other examples of suitable vehicles include any of a number of different types of ground vehicles (e.g., motor vehicles, railed vehicles), watercraft, amphibious vehicles, spacecraft and the like.

A vehicle generally includes a basic structure, and a propulsion system coupled to the basic structure. The basic structure is the main supporting structure of the vehicle to which other components are attached. The basic structure is the load-bearing framework of the vehicle that structurally supports the vehicle in its construction and function. In various contexts, the basic structure may be referred to as a chassis, an airframe or the like.

The propulsion system includes one or more engines or motors configured to power one or more propulsors to generate propulsive forces that cause the vehicle to move. A propulsor is any of a number of different means of converting power into a propulsive force. Examples of suitable propulsors include rotors, propellers, wheels and the like. In some examples, the propulsion system includes a drivetrain configured to deliver power from the engines/motors to the propulsors. The engines/motors and drivetrain may in some contexts be referred to as the powertrain of the vehicle.

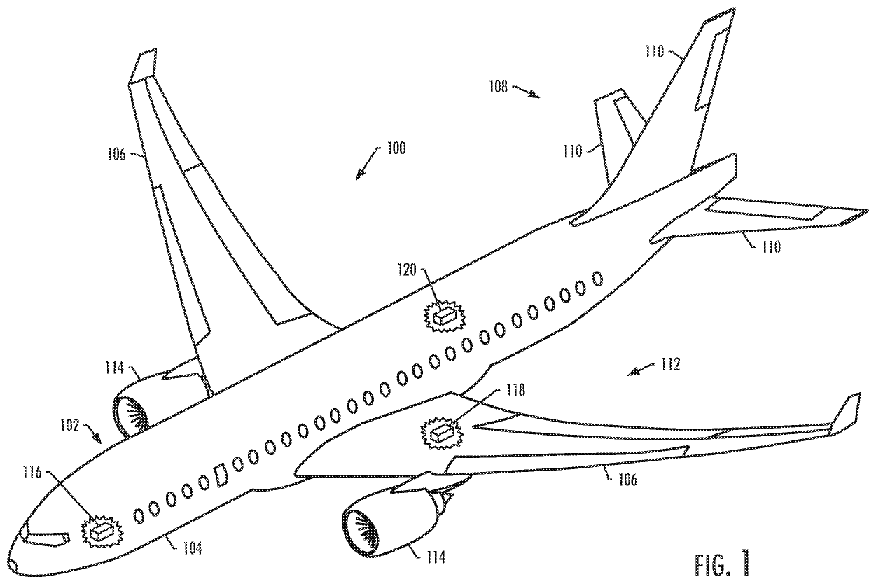

FIG. 1 illustrates one type of vehicle, namely, an aircraft 100 that may benefit from example implementations of the present disclosure. As shown, the aircraft includes a basic structure with an airframe 102 including a fuselage 104. The airframe also includes wings 106 that extend from opposing sides of the fuselage, an empennage or tail assembly 108 at a rear end of the fuselage, and the tail assembly includes stabilizers 110. The aircraft also includes a plurality of high-level systems 112 such as a propulsion system. In the particular example shown in FIG. 1, the propulsion system includes two wing-mounted engines 114 configured to power propulsors to generate propulsive forces that cause the aircraft to move. In other implementations, the propulsion system can include other arrangements, for example, engines carried by other portions of the aircraft including the fuselage and/or the tail. As also shown, the high-level systems may also include an electrical system 116, hydraulic system 118 and/or environmental system 120. Any number of other systems may be included.

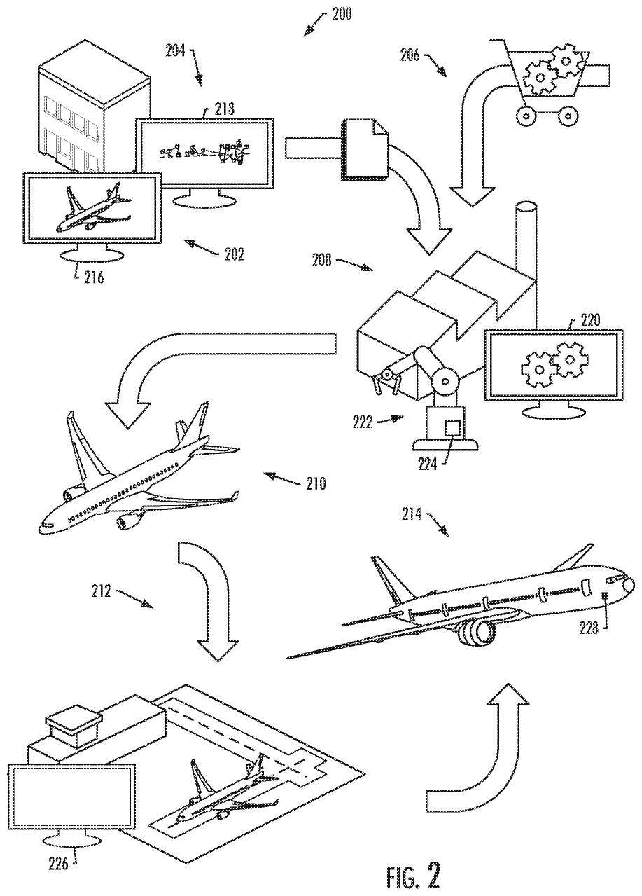

As explained above, example implementations of the present disclosure relate generally to vehicular engineering and, in particular, to one or more of the design, construction, operation or use of vehicles such as aircraft 100. Thus, referring now to FIG. 2, example implementations may be used in the context of an aircraft manufacturing and service method 200. During pre-production, the example method may include specification and design 202 of the aircraft, manufacturing sequence and processing planning 204 and material procurement 206. During production, component and subassembly manufacturing 208 and system integration 210 of the aircraft takes place. Thereafter, the aircraft may go through certification and delivery 212 in order to be placed in service 214. While in service by an operator, the aircraft may be scheduled for maintenance and service (which may also include modification, reconfiguration, refurbishment or the like).

Each of the processes of the example method 200 may be performed or carried out by a system integrator, third party and/or operator (e.g., customer). For the purposes of this description, a system integrator may include for example any number of aircraft manufacturers and major-system subcontractors; a third party may include for example any number of vendors, subcontractors and suppliers; and an operator may include for example an airline, leasing company, military entity, service organization or the like.

As will also be appreciated, computers are often used throughout the method 200; and in this regard, a “computer” is generally a machine that is programmable or programmed to perform functions or operations. The method as shown makes use of a number of example computers. These computers include computers 216, 218 used for the specification and design 202 of the aircraft, and the manufacturing sequence and processing planning 204. The method may also make use of computers 220 during component and subassembly manufacturing 208, which may also make use of computer numerical control (CNC) machines 222 or other robotics that are controlled by computers 224. Even further, computers 226 may be used while the aircraft is in service 214, as well as during maintenance and service; and as suggested in FIG. 1, the aircraft may itself include one or more computers 228 as part of or separate from its electrical system 116.

A number of the computers 216-228 used in the method 200 may be co-located or directly coupled to one another, or in some examples, various ones of the computers may communicate with one another across one or more computer networks. Further, although shown as part of the method, it should be understood that any one or more of the computers may function or operate separate from the method, without regard to any of the other computers. It should also be understood that the method may include one or more additional or alternative computers than those shown in FIG. 2.

Example implementations of the present disclosure may be implemented throughout the aircraft manufacturing and service method 200, but are particularly well suited for implementation as the aircraft is in service 214. In this regard, some example implementations provide a computer for predicting a reroute for a planned flight of an aircraft. The computer may be a computer 226 configured to operate as a flight planning system for use as a flight of the aircraft is planned. Additionally or alternatively, in some examples, the computer may be a computer 228 that is configured to operate as an electronic flight bag (EFB) for use onboard the aircraft as the planned flight is executed.

The present disclosure relates generally to operations of the aircraft 100 in an airspace system served by an air navigation service provider (ANSP). As introduced above, the airspace system includes an airspace, infrastructure and rules, regulations and the like for navigating the airspace. The ANSP is generally a public or private entity that provides air navigation services, and manages air traffic for an organization, region or country. One example of an ANSP in the United States is the Federal Aviation Administration (FAA). Examples of suitable airspace systems include the National Airspace System (NAS) and the new NextGen system that are served by the FAA.

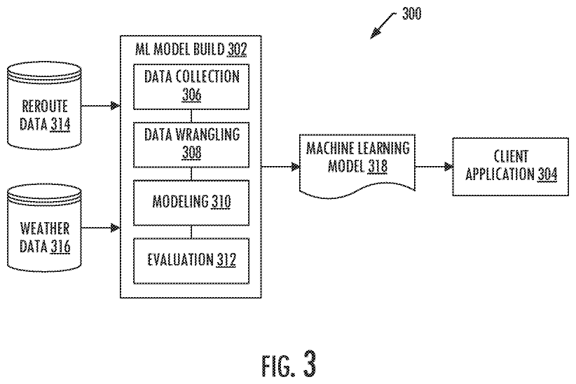

In particular, example implementations of the present disclosure are directed to predicting a reroute for a planned flight of the aircraft 100. In this regard, FIG. 3 is a block diagram of a system 300 for predicting a reroute for a planned flight of an aircraft, which may be implemented by either or both computer 226 or computer 228, according to example implementations of the present disclosure. The system includes any of a number of different subsystems (each an individual system) for performing one or more functions or operations. The subsystems may be co-located or directly coupled to one another, or in some examples, various ones of the subsystems may communicate with one another across one or more computer networks. It should also be understood that one or more of the subsystems may function or operate as a separate system without regard to any of the other subsystems, and that the system may include one or more additional or alternative subsystems than those shown in FIG. 3.

As shown in FIG. 3, in some examples, the system 300 includes one or more of each of a machine learning (ML) model building system 302 and a client application 304. As also shown, the ML model building system may include sub-components such as a data collection subsystem 306, a data wrangling subsystem 308, a modeling subsystem 310 and an evaluation subsystem 312. In some more particular examples, the ML model building system may be implemented as a software product having a microservice architecture. In this architecture, ML model building system may be arranged as a collection of loosely-coupled microservices including the data collection subsystem 306, data wrangling subsystem 308, modeling subsystem 310 and evaluation subsystem 312.

According to some example implementaions, the ML model building system 302 is configured to build a machine learning model 318 to predict a reroute on a future date of a planned flight of an aircraft in an airspace of an airspace system served by an ANSP such as the FAA. In this regard, the future date of the planned flight is classified as having a reroute advisory issued by the ANSP. Some example implementations involve reroutes of a number of reroute types; and in some of these examples, the ML model building system may be configured to build a machine learning model for a respective reroute type, or build multiple machine learning models for respective ones of multiple reroute types.

In some example implementations, the machine learning model 318 is built by the ML model building system 302 in a batch process at regularly occurring intervals. In this batch, the data collection subsystem 306 is configured to access reroute data 314 that describes historical reroute advisories with historical reroutes issued by the ANSP for flights in the airspace on certain dates over a given time period. In some implementations, the reroute data may be accessed from air traffic management information provided by the ANSP, such as via System Wide Information Management (SWIM) of the FAA. In some examples, the reroute data may further includes additional reroute data that describes the historical reroute advisories with the historical reroutes issued by the ANSP or another ANSP for flights in another airspace of the airspace system, or the airspace of another airspace system.

The data collection subsystem 306 also is configured to access weather data 316 that describes weather in the airspace on the certain dates. In some implementations, the weather data may be accessed from the global forecast system (GFS) run by the National Weather Service (NWS) in the United States. The weather data includes values of properties of the weather, and the data collection subsystem may be configured to perform a feature engineering in which select ones of the properties are selected as or transformed into a set of features from which a training set for the candidate machine learning models is produced. These select ones of the properties may include any one or more of precipitable water (PW), convective available potential energy (CAPE), air potential temperature (APT), or convective inhibition (CI).

The data wrangling subsystem 308 is configured to perform a data wrangling of the reroute data 314 and the weather data 316 to produce a collection of data that includes the reroute data and the weather data keyed by date. For the weather data in particular, the data wrangling may include dividing the airspace into areas. The data wrangling subsystem 308 may be configured to select an area of the areas through which the aircraft is planned to travel during the planned flight. The data wrangling subsystem is configured to perform an interpolation in time of the values of the select ones of the properties of the weather in the area. And the data wrangling subsystem is configured to calculate descriptive statistics of the select ones of the properties from the interpolation of the values. Examples of suitable descriptive statistics include one or more of a minimum (MIN), maximum (MAX), mean (MEAN) or standard deviation (STD). The collection of data, then, may include the weather data 316 as descriptive statistics of the select ones of the properties of the weather.

In some examples, the data wrangling subsystem 308 is configured to oversample the reroute data and the weather data in the collection of data to supplement the training set that may be produced from the collection of data. Additionally or alternatively, at least the weather data may be scaled to some standardized interval, such as using a standard scaler algorithm.

One example of a suitable oversampling technique that may be used to oversample the reroute data and the weather data is a combination of Synthetic Minority Over-sampling Technique (SMOTE) and Tomek links (SMOTETomek). In this regard, SMOTE may be used to interpolate the weather data for instances of the minority class in which historical reroute advisories were issued to generate artificial instances, and Tomek links may be used to clean the data. From this, the collection of data may include well-defined separation boundaries to support classification of a date as having a reroute advisory issued.

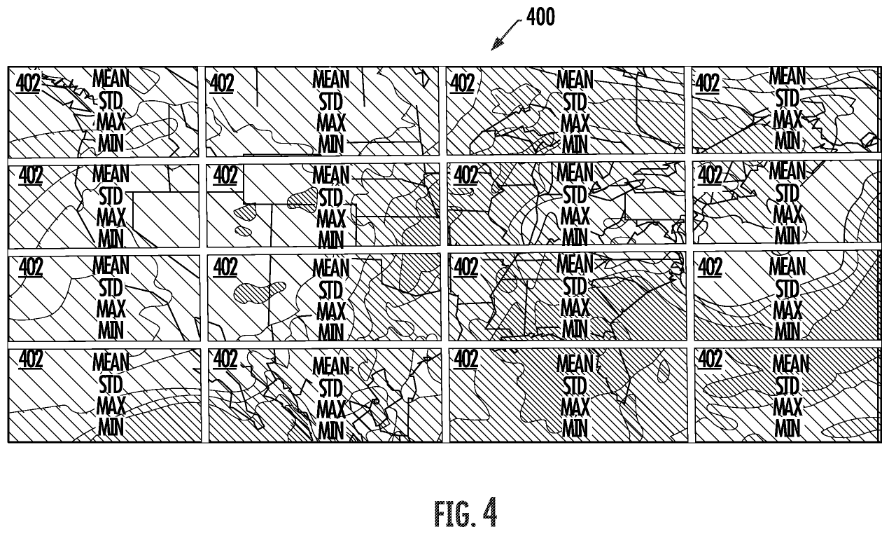

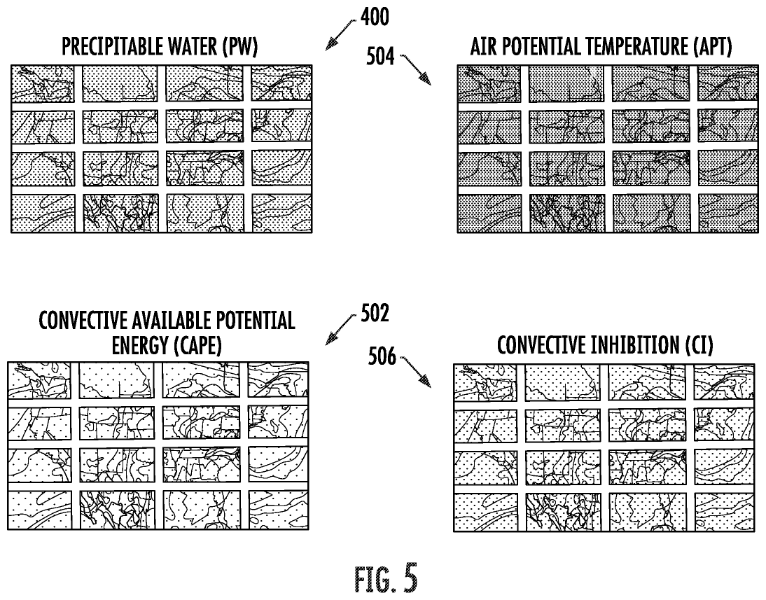

FIG. 4 is a map 400 of precipitable water (PW) in the airspace of the NAS. As shown, the airspace is divided into areas 402, and descriptive statistics including MIN, MAX, MEAN and STD are calculated for the precipitable water in respective ones of the areas. FIG. 5 illustrates the map 400 of precipitable water, and further illustrates similar maps 502, 504 and 506 of convective available potential energy (CAPE), air potential temperature (APT), and convective inhibition (CI), according to some example implementations.

Returning to FIG. 3, the modeling subsystem 310 is configured to build candidate machine learning models to predict the reroute on a given date that is classified as having a reroute advisory issued by the ANSP, using a training set produced from the collection of data, such as in the manner described above. In some examples, the candidate machine learning models are built from different machine learning algorithms including multiple ones of multilayer perceptron, support vector machine, extra trees, and gradient boosting.

The evaluation subsystem 312 is configured to evaluate candidate machine learning models to determine at least one evaluation metric of the candidate machine learning models, such as one or more of accuracy, precision, recall, or F1 score. And the ML model building system 302 is configured to select the machine learning model 318 from the candidate machine learning models based on the at least one evaluation metric. In some further examples, the historical reroutes are divided into reroute types, and the model building system is configured to build machine learning models for respective ones of the reroute type.

The model building system 302 is configured to output the machine learning model 318 (or machine learning models) for deployment from the client application 304, which in some examples may be a web-based client application that is integrated with a flight planning system. In this regard, the machine learning model may be deployed to classify the future date of the planned flight as having a reroute advisory issued by the ANSP, and predict and thereby produce a predicted reroute on the future date of the planned flight, based on forecasted weather data for the future date. In some examples, the client application is further configured to apply the forecasted weather data for the future date of the planned flight to the machine learning model to classify the future date as having the reroute advisory issued, and predict and thereby produce the predicted reroute on the future date.

FIG. 6 illustrates a graphical user interface (GUI) 600 that may be generated by the client application 304, according to some example implementations. The GUI includes a map 602 on which convective weather 604 is depicted with pixels in various colors from the center to the right side of the GUI, where the most severe weather is shown. The GUI also illustrates a reroute 606 of a flight of an aircraft from Las Vegas, Nevada to Dallas, Tex., to avoid the convective weather. As described above, example implementations of the present disclosure may predict the reroute using a machine learning model built from reroute data that describes historical reroute advisories with historical reroutes issued by an ANSP such as the FAA, and salient features of related weather data such as PW, CAPE, APT, CI and the like. This diverse set of salient features along with underlying predictive services may enable example implementations to produce a highly efficient and accurate prediction.

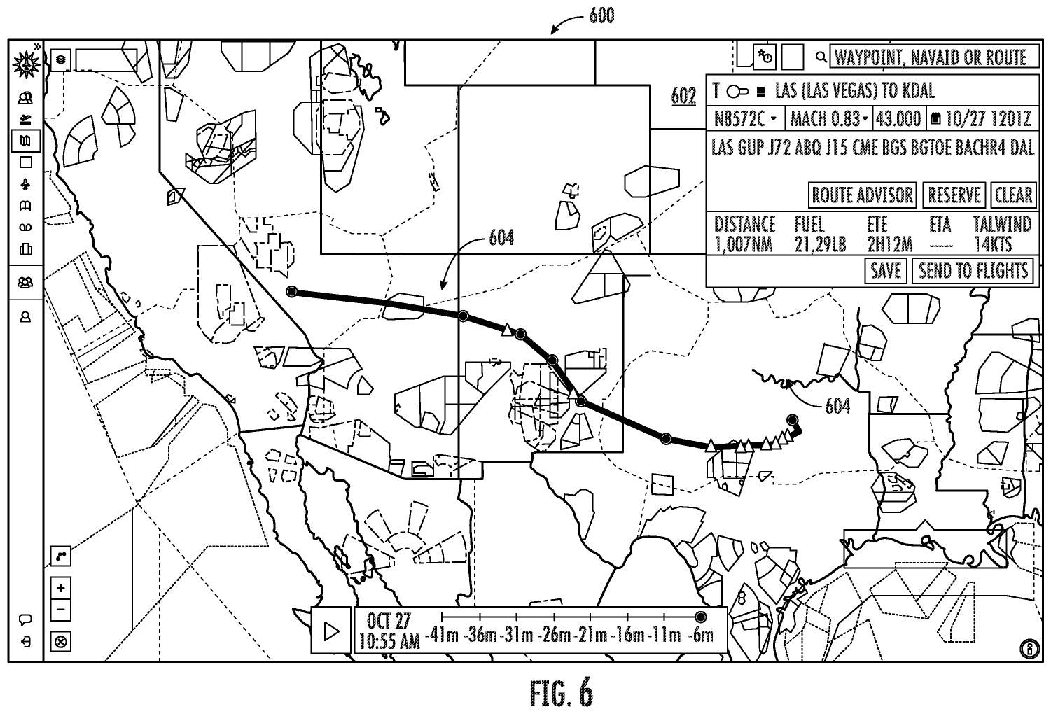

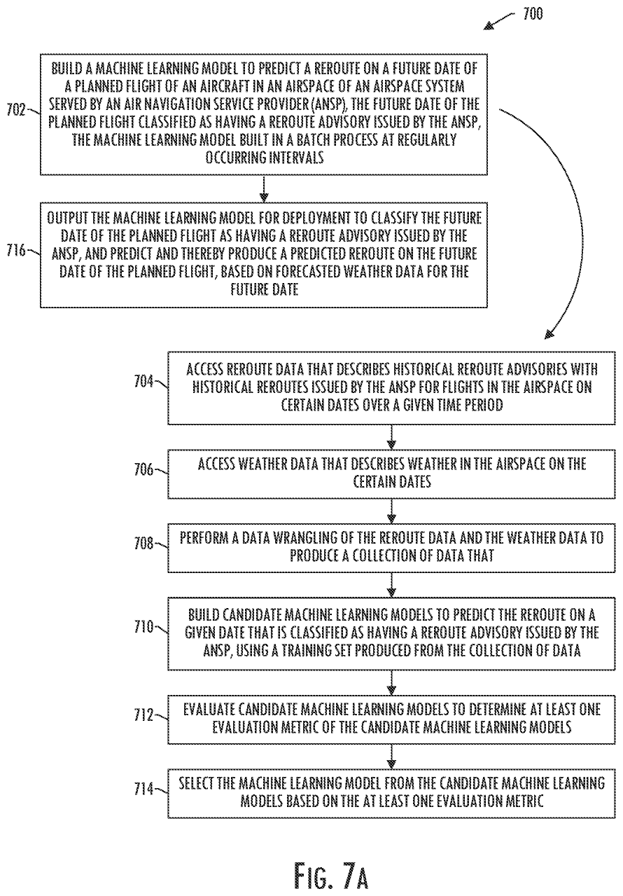

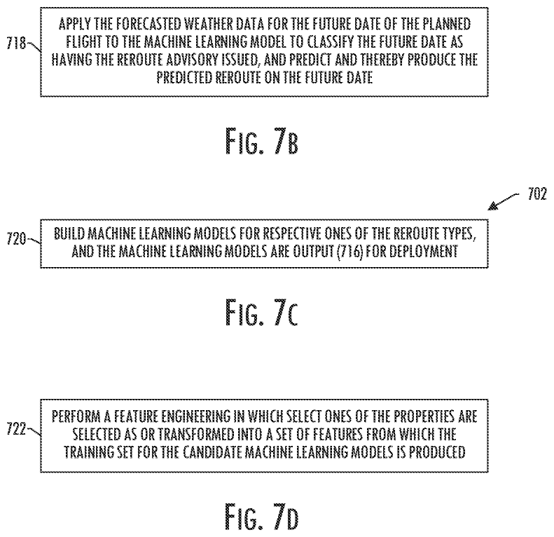

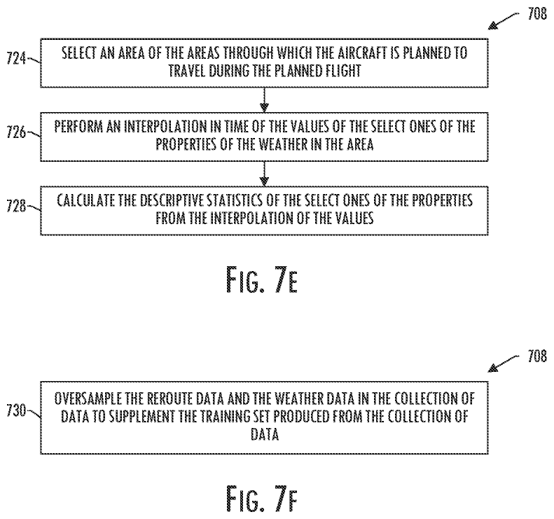

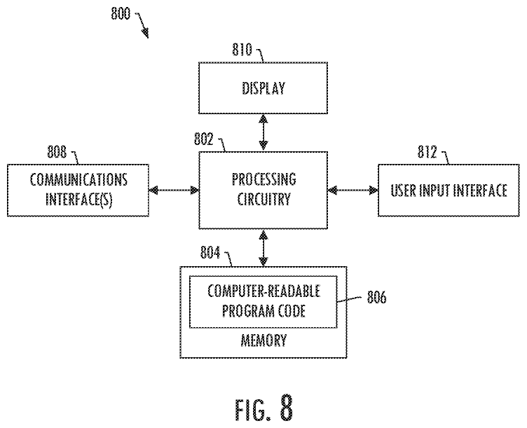

FIGS. 7A-7F are flowcharts illustrating various steps in a method 700 of predicting a reroute for a planned flight of an aircraft, according to various example implementations of the present disclosure. The method includes building a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, as shown at at block 702 of FIG. 7A.

The batch process includes accessing reroute data that describes historical reroute advisories with historical reroutes issued by the ANSP for flights in the airspace on certain dates over a given time period, as shown at block 704. The method includes accessing weather data that describes weather in the airspace on the certain dates, as shown at block 706. The batch process includes performing a data wrangling of the reroute data and the weather data to produce a collection of data that includes the reroute data and the weather data keyed by date, as shown at block 708. The batch process includes building candidate machine learning models to predict the reroute on a given date that is classified as having a reroute advisory issued by the ANSP, using a training set produced from the collection of data, as shown at block 710. The batch process includes evaluating candidate machine learning models to determine at least one evaluation metric of the candidate machine learning models, as shown at block 712. The batch process includes selecting the machine learning model from the candidate machine learning models based on the at least one evaluation metric, as shown at block 714. And the method includes outputting the machine learning model for deployment to classify the future date of the planned flight as having a reroute advisory issued by the ANSP, and predict and thereby produce a predicted reroute on the future date of the planned flight, based on forecasted weather data for the future date, as shown at block 716.

In some examples, the method 700 further includes applying the forecasted weather data for the future date of the planned flight to the machine learning model to classify the future date as having the reroute advisory issued, and predict and thereby produce the predicted reroute on the future date, as shown at block 718 of FIG. 7B.

In some examples, the machine learning model is built at block 702 by a software product having a microservice architecture in which the software product is arranged as a collection of loosely-coupled microservices that are implemented to carry out the batch process.

In some examples, the historical reroutes are divided into reroute types, and building the machine learning model at block 702 includes building machine learning models for respective ones of the reroute types, as shown at block 720 of FIG. 7C. In some of these examples, the machine learning models are output for deployment at block 716.

In some examples, the weather data includes values of properties of the weather. The method further includes performing a feature engineering in which select ones of the properties are selected as or transformed into a set of features from which the training set for the candidate machine learning models is produced, as shown at block 722 of FIG. 7D.

In some examples, the select ones of the properties include precipitable water, convective available potential energy, air potential temperature, and convective inhibition.

In some examples, the collection of data includes the weather data as descriptive statistics of the select ones of the properties of the weather. In some examples, the airspace is divided into areas, and performing the data wrangling at block 708 includes selecting an area of the areas through which the aircraft is planned to travel during the planned flight, as shown at block 724 of FIG. 7E. The method includes performing an interpolation in time of the values of the select ones of the properties of the weather in the area, as shown at block 726. And the method includes calculating the descriptive statistics of the select ones of the properties from the interpolation of the values, as shown at block 728.

In some examples, performing the data wrangling at block 708 includes oversampling the reroute data and the weather data in the collection of data to supplement the training set produced from the collection of data, as shown at block 730 of FIG. 7F.

In some examples, the reroute data and the weather data are oversampled at block 730 using a combination of Synthetic Minority Over-sampling Technique (SMOTE) and Tomek links (SMOTETomek).

In some examples, the candidate machine learning models are built at block 710 from different machine learning algorithms including multiple ones of multilayer perceptron, support vector machine, extra trees, and gradient boosting.

In some examples, the at least one evaluation metric from which the machine learning model is selected at block 714 includes one or more of accuracy, precision, recall, or F1 score.

In some examples, the reroute data that is accessed at block 704 further includes additional reroute data that describes the historical reroute advisories with the historical reroutes issued by the ANSP or another ANSP for flights in another airspace of the airspace system, or the airspace of another airspace system.

In some examples, the machine learning model is output at block 716 for deployment from a web-based client application that is integrated with a flight planning system.

According to example implementations of the present disclosure, again, the system 300 for predicting a reroute for a planned flight of an aircraft 100 may be implemented by either or both computer 226 or computer 228. The computer, in turn, may include hardware, alone or under direction of one or more computer programs from a computer-readable storage medium. In some examples, one or more apparatuses may be configured to function as or otherwise implement the computer shown and described herein. In examples involving more than one apparatus, the respective apparatuses may be connected to or otherwise in communication with one another in a number of different manners, such as directly or indirectly via a wired or wireless network or the like.

FIG. 8 illustrates an apparatus 800 according to some example implementations of the present disclosure. Generally, an apparatus of exemplary implementations of the present disclosure may comprise, include or be embodied in one or more fixed or portable electronic devices. Examples of suitable electronic devices include a smartphone, tablet computer, laptop computer, desktop computer, workstation computer, server computer or the like. The apparatus may include one or more of each of a number of components such as, for example, processing circuitry 802 (e.g., processor unit) connected to a memory 804 (e.g., storage device).

The processing circuitry 802 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 804 (of the same or another apparatus).

The processing circuitry 802 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 804 is generally any piece of computer hardware that is capable of storing information such as, for example, data, computer programs (e.g., computer-readable program code 806) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 804, the processing circuitry 802 may also be connected to one or more interfaces for displaying, transmitting and/or receiving information. The interfaces may include a communications interface 808 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 810 and/or one or more user input interfaces 812 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 800 may include a processing circuitry 802 and a computer-readable storage medium or memory 804 coupled to the processing circuitry, where the processing circuitry is configured to execute computer-readable program code 806 stored in the memory. It will also be understood that one or more functions, and combinations of functions, may be implemented by special purpose hardware-based computer systems and/or processing circuitry which perform the specified functions, or combinations of special purpose hardware and program code instructions.

As explained above and reiterated below, the present disclosure includes, without limitation, the following example implementations.

Clause 1. An apparatus for predicting a reroute for a planned flight of an aircraft, the apparatus comprising: a memory configured to store computer-readable program code; and processing circuitry configured to access the memory, and execute the computer-readable program code to cause the apparatus to at least: build a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, the batch process including the apparatus caused to: access reroute data that describes historical reroute advisories with historical reroutes issued by the ANSP for flights in the airspace on certain dates over a given time period; access weather data that describes weather in the airspace on the certain dates; perform a data wrangling of the reroute data and the weather data to produce a collection of data that includes the reroute data and the weather data keyed by date; build candidate machine learning models to predict the reroute on a given date that is classified as having a reroute advisory issued by the ANSP, using a training set produced from the collection of data; evaluate candidate machine learning models to determine at least one evaluation metric of the candidate machine learning models; and select the machine learning model from the candidate machine learning models based on the at least one evaluation metric; and output the machine learning model for deployment to classify the future date of the planned flight as having a reroute advisory issued by the ANSP, and predict and thereby produce a predicted reroute on the future date of the planned flight, based on forecasted weather data for the future date.

Clause 2. The apparatus of clause 1, wherein the processing circuitry is configured to execute the computer-readable program code to cause the apparatus to further apply the forecasted weather data for the future date of the planned flight to the machine learning model to classify the future date as having the reroute advisory issued, and predict and thereby produce the predicted reroute on the future date.

Clause 3. The apparatus of clause 1 or clause 2, wherein the machine learning model is built by a software product having a microservice architecture in which the software product is arranged as a collection of loosely-coupled microservices that are implemented to carry out the batch process.

Clause 4. The apparatus of any of clauses 1 to 3, wherein the historical reroutes are divided into reroute types, and the apparatus caused to build the machine learning model includes the apparatus caused to build machine learning models for respective ones of the reroute types, and the machine learning models are output for deployment.

Clause 5. The apparatus of any of clauses 1 to 4, wherein the weather data includes values of properties of the weather, and the processing circuitry is configured to execute the computer-readable program code to cause the apparatus to further perform a feature engineering in which select ones of the properties are selected as or transformed into a set of features from which the training set for the candidate machine learning models is produced.

Clause 6. The apparatus of clause 5, wherein the select ones of the properties include precipitable water, convective available potential energy, air potential temperature, and convective inhibition.

Clause 7. The apparatus of clause 5 or clause 6, wherein the collection of data includes the weather data as descriptive statistics of the select ones of the properties of the weather.

Clause 8. The apparatus of clause 7, wherein the airspace is divided into areas, and the apparatus caused to perform the data wrangling includes the apparatus caused to: select an area of the areas through which the aircraft is planned to travel during the planned flight; perform an interpolation in time of the values of the select ones of the properties of the weather in the area; and calculate the descriptive statistics of the select ones of the properties from the interpolation of the values.

Clause 9. The apparatus of any of clauses 1 to 8, wherein the apparatus caused to perform the data wrangling includes the apparatus caused to oversample the reroute data and the weather data in the collection of data to supplement the training set produced from the collection of data.

Clause 10. The apparatus of clause 9, wherein the reroute data and the weather data are oversampled using a combination of Synthetic Minority Over-sampling Technique (SMOTE) and Tomek links (SMOTETomek).

Clause 11. The apparatus of any of clauses 1 to 10, wherein the candidate machine learning models are built from different machine learning algorithms including multiple ones of multilayer perceptron, support vector machine, extra trees, and gradient boosting.

Clause 12. The apparatus of any of clauses 1 to 11, wherein the at least one evaluation metric from which the machine learning model is selected includes one or more of accuracy, precision, recall, or F1 score.

Clause 13. The apparatus of any of clauses 1 to 12, wherein the reroute data that is accessed further includes additional reroute data that describes the historical reroute advisories with the historical reroutes issued by the ANSP or another ANSP for flights in another airspace of the airspace system, or the airspace of another airspace system.

Clause 14. The apparatus of any of clauses 1 to 13, wherein the machine learning model is output for deployment from a web-based client application that is integrated with a flight planning system.

Clause 15. A method of predicting a reroute for a planned flight of an aircraft, the method comprising: building a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, the batch process including: accessing reroute data that describes historical reroute advisories with historical reroutes issued by the ANSP for flights in the airspace on certain dates over a given time period; accessing weather data that describes weather in the airspace on the certain dates; performing a data wrangling of the reroute data and the weather data to produce a collection of data that includes the reroute data and the weather data keyed by date; building candidate machine learning models to predict the reroute on a given date that is classified as having a reroute advisory issued by the ANSP, using a training set produced from the collection of data; evaluating candidate machine learning models to determine at least one evaluation metric of the candidate machine learning models; and selecting the machine learning model from the candidate machine learning models based on the at least one evaluation metric; and outputting the machine learning model for deployment to classify the future date of the planned flight as having a reroute advisory issued by the ANSP, and predict and thereby produce a predicted reroute on the future date of the planned flight, based on forecasted weather data for the future date.

Clause 16. The method of clause 15, wherein the method further comprises applying the forecasted weather data for the future date of the planned flight to the machine learning model to classify the future date as having the reroute advisory issued, and predict and thereby produce the predicted reroute on the future date.

Clause 17. The method of clause 15 or clause 16, wherein the machine learning model is built by a software product having a microservice architecture in which the software product is arranged as a collection of loosely-coupled microservices that are implemented to carry out the batch process.

Clause 18. The method of any of clauses 15 to 17, wherein the historical reroutes are divided into reroute types, and building the machine learning model includes building machine learning models for respective ones of the reroute types, and the machine learning models are output for deployment.

Clause 19. The method of any of clauses 15 to 18, wherein the weather data includes values of properties of the weather, and the method further comprises performing a feature engineering in which select ones of the properties are selected as or transformed into a set of features from which the training set for the candidate machine learning models is produced.

Clause 20. The method of clause 19, wherein the select ones of the properties include precipitable water, convective available potential energy, air potential temperature, and convective inhibition.

Clause 21. The method of clause 19 or clause 20, wherein the collection of data includes the weather data as descriptive statistics of the select ones of the properties of the weather.

Clause 22. The method of clause 21, wherein the airspace is divided into areas, and performing the data wrangling includes: selecting an area of the areas through which the aircraft is planned to travel during the planned flight; performing an interpolation in time of the values of the select ones of the properties of the weather in the area; and calculating the descriptive statistics of the select ones of the properties from the interpolation of the values.

Clause 23. The method of any of clauses 15 to 22, wherein performing the data wrangling includes oversampling the reroute data and the weather data in the collection of data to supplement the training set produced from the collection of data.

Clause 24. The method of clause 23, wherein the reroute data and the weather data are oversampled using a combination of Synthetic Minority Over-sampling Technique (SMOTE) and Tomek links (SMOTETomek).

Clause 25. The method of any of clauses 15 to 24, wherein the candidate machine learning models are built from different machine learning algorithms including multiple ones of multilayer perceptron, support vector machine, extra trees, and gradient boosting.

Clause 26. The method of any of clauses 15 to 25, wherein the at least one evaluation metric from which the machine learning model is selected includes one or more of accuracy, precision, recall, or F1 score.

Clause 27. The method of any of clauses 15 to 26, wherein the reroute data that is accessed further includes additional reroute data that describes the historical reroute advisories with the historical reroutes issued by the ANSP or another ANSP for flights in another airspace of the airspace system, or the airspace of another airspace system.

Clause 28. The method of any of clauses 15 to 27, wherein the machine learning model is output for deployment from a web-based client application that is integrated with a flight planning system.

Clause 29. A computer-readable storage medium for predicting a reroute for a planned flight of an aircraft, the computer-readable storage medium being non-transitory and having computer-readable program code stored therein that, in response to execution by processing circuitry, causes an apparatus to at least: build a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, the batch process including the apparatus caused to: access reroute data that describes historical reroute advisories with historical reroutes issued by the ANSP for flights in the airspace on certain dates over a given time period; access weather data that describes weather in the airspace on the certain dates; perform a data wrangling of the reroute data and the weather data to produce a collection of data that includes the reroute data and the weather data keyed by date; build candidate machine learning models to predict the reroute on a given date that is classified as having a reroute advisory issued by the ANSP, using a training set produced from the collection of data; evaluate candidate machine learning models to determine at least one evaluation metric of the candidate machine learning models; and select the machine learning model from the candidate machine learning models based on the at least one evaluation metric; and output the machine learning model for deployment to classify the future date of the planned flight as having a reroute advisory issued by the ANSP, and predict and thereby produce a predicted reroute on the future date of the planned flight, based on forecasted weather data for the future date.

Clause 30. The computer-readable storage medium of clause 29, wherein the computer-readable storage medium has further computer-readable program code stored therein that, in response to execution by the processing circuitry, causes the apparatus to further apply the forecasted weather data for the future date of the planned flight to the machine learning model to classify the future date as having the reroute advisory issued, and predict and thereby produce the predicted reroute on the future date.

Clause 31. The computer-readable storage medium of clause 29 or clause 30, wherein the machine learning model is built by a software product having a microservice architecture in which the software product is arranged as a collection of loosely-coupled microservices that are implemented to carry out the batch process.

Clause 32. The computer-readable storage medium of any of clauses 29 to 31, wherein the historical reroutes are divided into reroute types, and the apparatus caused to build the machine learning model includes the apparatus caused to build machine learning models for respective ones of the reroute types, and the machine learning models are output for deployment.

Clause 33. The computer-readable storage medium of any of clauses 29 to 32, wherein the weather data includes values of properties of the weather, and the computer-readable storage medium has further computer-readable program code stored therein that, in response to execution by the processing circuitry, causes the apparatus to further perform a feature engineering in which select ones of the properties are selected as or transformed into a set of features from which the training set for the candidate machine learning models is produced.

Clause 34. The computer-readable storage medium of clause 33, wherein the select ones of the properties include precipitable water, convective available potential energy, air potential temperature, and convective inhibition.

Clause 35. The computer-readable storage medium of clause 33 or clause 34, wherein the collection of data includes the weather data as descriptive statistics of the select ones of the properties of the weather.

Clause 36. The computer-readable storage medium of clause 35, wherein the airspace is divided into areas, and the apparatus caused to perform the data wrangling includes the apparatus caused to: select an area of the areas through which the aircraft is planned to travel during the planned flight; perform an interpolation in time of the values of the select ones of the properties of the weather in the area; and calculate the descriptive statistics of the select ones of the properties from the interpolation of the values.

Clause 37. The computer-readable storage medium of any of clauses 29 to 36, wherein the apparatus caused to perform the data wrangling includes the apparatus caused to oversample the reroute data and the weather data in the collection of data to supplement the training set produced from the collection of data.

Clause 38. The computer-readable storage medium of clause 37, wherein the reroute data and the weather data are oversampled using a combination of Synthetic Minority Over-sampling Technique (SMOTE) and Tomek links (SMOTETomek).

Clause 39. The computer-readable storage medium of any of clauses 29 to 38, wherein the candidate machine learning models are built from different machine learning algorithms including multiple ones of multilayer perceptron, support vector machine, extra trees, and gradient boosting.

Clause 40. The computer-readable storage medium of any of clauses 29 to 39, wherein the at least one evaluation metric from which the machine learning model is selected includes one or more of accuracy, precision, recall, or F1 score.

Clause 41. The computer-readable storage medium of any of clauses 29 to 40, wherein the reroute data that is accessed further includes additional reroute data that describes the historical reroute advisories with the historical reroutes issued by the ANSP or another ANSP for flights in another airspace of the airspace system, or the airspace of another airspace system.

Clause 42. The computer-readable storage medium of any of clauses 29 to 41, wherein the machine learning model is output for deployment from a web-based client application that is integrated with a flight planning system.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for predicting a reroute for a planned flight of an aircraft, the apparatus comprising:
a memory configured to store computer-readable program code; and
processing circuitry configured to access the memory, and execute the computer-readable program code to cause the apparatus to at least:
build a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, the batch process including the apparatus caused to:
access reroute data that describes historical reroute advisories with historical reroutes issued by the ANSP for flights in the airspace on certain dates over a given time period;
access weather data that describes weather in the airspace on the certain dates;
perform a data wrangling of the reroute data and the weather data to produce a collection of data that includes the reroute data and the weather data keyed by date;
build candidate machine learning models to predict the reroute on a given date that is classified as having a reroute advisory issued by the ANSP, using a training set produced from the collection of data;
evaluate candidate machine learning models to determine at least one evaluation metric of the candidate machine learning models; and
select the machine learning model from the candidate machine learning models based on the at least one evaluation metric; and
output the machine learning model for deployment to classify the future date of the planned flight as having a reroute advisory issued by the ANSP, and predict and thereby produce a predicted reroute on the future date of the planned flight, based on forecasted weather data for the future date.

2. The apparatus of claim 1, wherein the processing circuitry is configured to execute the computer-readable program code to cause the apparatus to further apply the forecasted weather data for the future date of the planned flight to the machine learning model to classify the future date as having the reroute advisory issued, and predict and thereby produce the predicted reroute on the future date.

3. The apparatus of claim 1, wherein the machine learning model is built by a software product having a microservice architecture in which the software product is arranged as a collection of loosely-coupled microservices that are implemented to carry out the batch process.

4. The apparatus of claim 1, wherein the weather data includes values of properties of the weather, and the processing circuitry is configured to execute the computer-readable program code to cause the apparatus to further perform a feature engineering in which select ones of the properties are selected as or transformed into a set of features from which the training set for the candidate machine learning models is produced.

5. The apparatus of claim 4, wherein the select ones of the properties include precipitable water, convective available potential energy, air potential temperature, and convective inhibition.

6. The apparatus of claim 4, wherein the collection of data includes the weather data as descriptive statistics of the select ones of the properties of the weather, and
wherein the airspace is divided into areas, and the apparatus caused to perform the data wrangling includes the apparatus caused to:
select an area of the areas through which the aircraft is planned to travel during the planned flight;
perform an interpolation in time of the values of the select ones of the properties of the weather in the area; and
calculate the descriptive statistics of the select ones of the properties from the interpolation of the values.

7. The apparatus of claim 1, wherein the apparatus caused to perform the data wrangling includes the apparatus caused to oversample the reroute data and the weather data in the collection of data to supplement the training set produced from the collection of data, and
wherein the reroute data and the weather data are oversampled using a combination of Synthetic Minority Over-sampling Technique (SMOTE) and Tomek links (SMOTETomek).

8. The apparatus of claim 1, wherein the at least one evaluation metric from which the machine learning model is selected includes one or more of accuracy, precision, recall, or F1 score.

9. The apparatus of claim 1, wherein the reroute data that is accessed further includes additional reroute data that describes the historical reroute advisories with the historical reroutes issued by the ANSP or another ANSP for flights in another airspace of the airspace system, or the airspace of another airspace system.

10. The apparatus of claim 1, wherein the machine learning model is output for deployment from a web-based client application that is integrated with a flight planning system.

11. A method of predicting a reroute for a planned flight of an aircraft, the method comprising:
building a machine learning model to predict a reroute on a future date of a planned flight of an aircraft in an airspace of an airspace system served by an air navigation service provider (ANSP), the future date of the planned flight classified as having a reroute advisory issued by the ANSP, the machine learning model built in a batch process at regularly occurring intervals, the batch process including:
accessing reroute data that describes historical reroute advisories with historical reroutes issued by the ANSP for flights in the airspace on certain dates over a given time period;
accessing weather data that describes weather in the airspace on the certain dates;
performing a data wrangling of the reroute data and the weather data to produce a collection of data that includes the reroute data and the weather data keyed by date;
building candidate machine learning models to predict the reroute on a given date that is classified as having a reroute advisory issued by the ANSP, using a training set produced from the collection of data;
evaluating candidate machine learning models to determine at least one evaluation metric of the candidate machine learning models; and
selecting the machine learning model from the candidate machine learning models based on the at least one evaluation metric; and
outputting the machine learning model for deployment to classify the future date of the planned flight as having a reroute advisory issued by the ANSP, and predict and thereby produce a predicted reroute on the future date of the planned flight, based on forecasted weather data for the future date.

12. The method of claim 11, wherein the method further comprises applying the forecasted weather data for the future date of the planned flight to the machine learning model to classify the future date as having the reroute advisory issued, and predict and thereby produce the predicted reroute on the future date.

13. The method of claim 11, wherein the machine learning model is built by a software product having a microservice architecture in which the software product is arranged as a collection of loosely-coupled microservices that are implemented to carry out the batch process.

14. The method of claim 11, wherein the weather data includes values of properties of the weather, and the method further comprises performing a feature engineering in which select ones of the properties are selected as or transformed into a set of features from which the training set for the candidate machine learning models is produced.

15. The method of claim 14, wherein the select ones of the properties include precipitable water, convective available potential energy, air potential temperature, and convective inhibition.

16. The method of claim 14, wherein the collection of data includes the weather data as descriptive statistics of the select ones of the properties of the weather, and
wherein the airspace is divided into areas, and performing the data wrangling includes:
selecting an area of the areas through which the aircraft is planned to travel during the planned flight;
performing an interpolation in time of the values of the select ones of the properties of the weather in the area; and
calculating the descriptive statistics of the select ones of the properties from the interpolation of the values.

17. The method of claim 11, wherein performing the data wrangling includes oversampling the reroute data and the weather data in the collection of data to supplement the training set produced from the collection of data, and
wherein the reroute data and the weather data are oversampled using a combination of Synthetic Minority Over-sampling Technique (SMOTE) and Tomek links (SMOTETomek).

18. The method of claim 11, wherein the at least one evaluation metric from which the machine learning model is selected includes one or more of accuracy, precision, recall, orFI score.

19. The method of claim 11, wherein the reroute data that is accessed further includes additional reroute data that describes the historical reroute advisories with the historical reroutes issued by the ANSP or another ANSP for flights in another airspace of the airspace system, or the airspace of another airspace system.

20. The method of claim 11, wherein the machine learning model is output for deployment from a web-based client application that is integrated with a flight planning system.
